(19) United States
(12) Patent Application Publication
(10) Pub. No.: US 2025/0158296 A1
(43) Pub. Date: May 15, 2025

(54) RECONFIGURABLE TRANSPONDER

(71) Applicant: Textron Aviation Inc., Wichita, KS (US)

(72) Inventors: Victoria MATTINGLY, Wichita, KS (US); Eric THOMAS, Wichita, KS (US); Gavin Thomas SMITH, Wichita, KS (US); Justin Courtenay MARTIN, Wichita, KS (US); Seth RUNYAN, Wichita, KS (US)

(21) Appl. No.: 18/947,655

(22) Filed: Nov. 14, 2024

Related U.S. Application Data
(60) Provisional application No. 63/598,672, filed on Nov. 14, 2023.

(51) Int. Cl. H01Q 21/28; H01Q 1/22; H01Q 1/28

(52) U.S. Cl. CPC H01Q 21/28; H01Q 1/2208; H01Q 1/28

(57) ABSTRACT

The technology of this application is generally directed to a method for temporary installation of a third military transponder while maintaining an existing dual civil transponder architecture. In one example embodiment, coax relays are installed between one of the civil transponders, the corresponding antennas, and the military transponder. A switch is installed to drive the coax relays and determine which transponder (e.g., civil or military) is connected to the antennas. The circuit breaker of the transponder not being used at the time can be pulled and collared to remove power to the equipment, and a software configuration loader card is used to configure the avionics.

### CROSS REFERENCE TO RELATED APPLICATION(S)

This application claims priority to U.S. Patent Application No. 63/598,672, filed Nov. 14, 2023, the entire contents of which are incorporated herein by reference.

### BACKGROUND

Techniques exist for modifying commercial aircraft to military application. In one example embodiment, various equipment on a commercial aircraft (e.g., radios, transponders, antennas) can be modified, added to, or replaced in order to allow the aircraft to operate in a military capacity. When modifying a commercial aircraft for special mission applications, often a military transponder is required. Conventional approaches for incorporating the military transponder into the aircraft include (1) permanently replacing one of the existing dual civil transponders with the military transponder, or (2) permanently installing the military transponder as a third transponder.

Under the first approach, the configuration for permanently replacing one of the civil transponders has less redundancy which potentially results in the aircraft being unable to dispatch if a transponder fails. Moreover, if a failure occurs to the military transponder (e.g., while the aircraft is deployed in international territory), it can be difficult to obtain replacement parts for the transponder (e.g., due to export and trade restrictions). The second approach typically involves expensive changes to the avionics system of the aircraft.

Accordingly, it will be appreciated that new and improved techniques, systems, and processes are continually sought after.

### BRIEF DESCRIPTION OF THE DRAWINGS

The foregoing and other objects, features and/or advantages will be apparent from the following description of particular embodiments, as illustrated in the accompanying drawings in which like reference characters refer to the same parts throughout the different views. The drawings are not necessarily to scale, emphasis instead being placed upon illustrating the principles of various example embodiments. Each embodiment herein may be used in combination with any other embodiment(s) described herein.

FIG. 1 shows a non-limiting example diagram of panel inside of an aircraft;

FIG. 2 shows a non-limiting example diagram of a configuration for various components of an aircraft;

FIG. 3 shows a non-limiting example diagram of different transponder configurations; and

FIG. 4 shows a non-limiting example diagram of a system 1 for a reconfigurable transponder.

### DETAILED DESCRIPTION OF EXAMPLE EMBODIMENTS

### Overview

The technology of this application is generally directed to a method and/or configuration for temporary installation of a third military transponder while maintaining an existing dual civil transponder architecture (e.g., without extensive modification of the avionics to accommodate three transponders). In one example embodiment, coax relays are installed between one of the civil transponders, the corresponding antennas, and the military transponder. A switch is installed to drive the coax relays and determine which transponder (e.g., civil or military) is connected to the antennas. A jumper harness is installed between the Identification Friend or Foe (IFF) and the avionics (civil) or the military position source. The circuit breaker of the transponder not being used at the time can be pulled and collared to remove power to the equipment, and a software configuration loader card is used to configure the avionics.

It should be appreciated that installation of the military transponder is designed such that when installed it temporarily replaces one of the existing dual civil transponders, rather than permanently replacing one of them or being permanently installed. The temporary, reconfigurable, aspect of this design is unique compared to traditional designs, and can be accomplished by coax relays tied to a switch, setting power by circuit breakers, jumper harness, and a loader card to configure the avionics. It should be appreciated that the term “civil transponder” can, in a non-limiting example embodiment, refer to a “civilian” transponder. For purposes of brevity, the “civilian” transponder will simply be referred to as a “civil transponder” herein. The acronym XPDR will be used to refer to a transponder (either civil or military).

It should also be appreciated that some of the components described in the figures (and throughout any other portion of this document) may be referred to as singular or plural components. However, these descriptions are for illustration purposes and are non-limiting. For example, if a component is referred to as a system, it should be understood that the system could comprise a single component, or could be multiple components (included distributed components). Likewise, if a component is referred to as a plurality, it should be appreciated that the component may also be implemented via a single component as well.

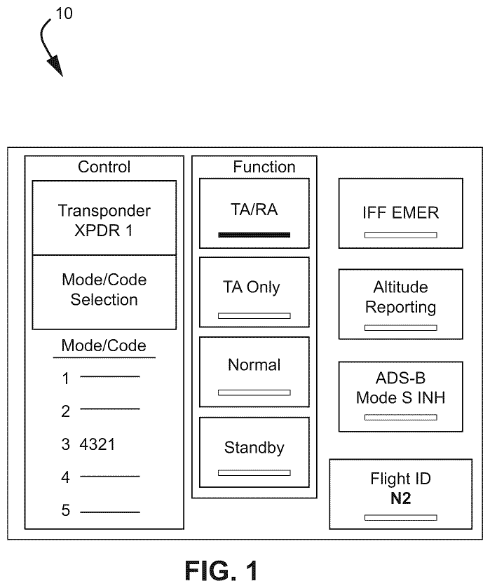

FIG. 1 shows a non-limiting example diagram of a display. Such display may be provided in association with equipment in a cockpit of an aircraft. It should be appreciated that a typical cockpit will include an instrument panel that displays information about the flight (e.g., altitude, speed). The panel may include gauges that monitor the engine(s) performance and may also include digital electronic flight instruments to provide accurate navigational and flight data. The instrument panel may include traditional analogue gauges and/or more contemporary primary flight display and navigation display. Of course, the cockpit may also likely include one or more transponders that can (among other aspects) assist the aircraft in identifying itself on air traffic control radar.

It should be appreciated that a transponder is an avionic system located on board the aircraft that provides information about the aircraft identification and barometric altitude to an Air Traffic Control (ATC) system on the ground and to Traffic Collision Avoidance System (TCAS) on other aircraft. The reply from the transponder is also used by radar on the ground to determine the position of the aircraft. The information to the ground is provided in response to an interrogation by systems such as secondary surveillance radar (SSR), or multilateration systems. ADS-B (Automatic Dependent Surveillance—Broadcast) capable transponders also allow the aircraft to ‘broadcast’ information to ground stations and other aircraft without interrogation. It should be appreciated that transponders are not just carried by commercial aircraft, but are also used by helicopters and military aircraft, among other aircraft as well as surface vehicles.

The total loss of a transponder for an aircraft in flight results in no transponder based data for an aircraft (identification and altitude) being presented on the Controller Working Position (CWP). This means that altitude information is lost. Modern passenger aircraft will typically carry two transponders. One is operating and the other serves as a back-up. Both are fed by separate altimeters, with the active transponder typically being fed by the altimeter used by the pilot flying the aircraft.

FIG. 1 specifically shows a display 10 for displaying, among other items, information associated with operating an aircraft. In one example embodiment, the display 10 allows the user to view and/or enter input. The display 10 can be used in association with one or more transponders, where the display 10 may include a transponder-control panel allowing the user to view and/or enter input to either transponder. It should be appreciated that other aircraft may operate with transponder equipment that is not associated with any particular display and the example shown in FIG. 1 is non-limiting.

It should be further appreciated, and as noted herein, that a commercial aircraft may include (at least) two transponders. A first transponder may serve as a primary transponder while a second transponder may serve as a backup transponder. Should one of the two transponders fail during flight, the other operating transponder can operate as a back-up transponder (e.g., to ensure flight safety).

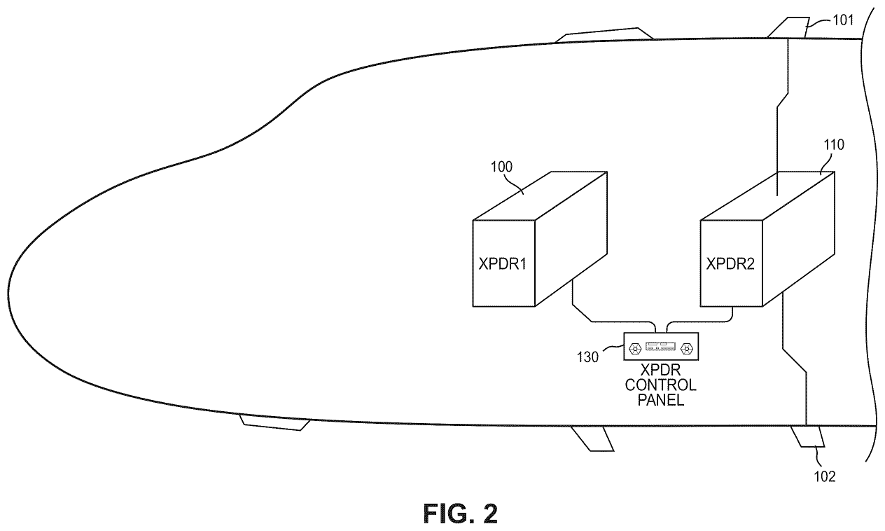

FIG. 2 shows a non-limiting example diagram of one or more components of an aircraft. It should be appreciated that a typical aircraft will include a multitude of components for operating/flying the aircraft. The example shown in FIG. 2 only depicts a few components for brevity.

In more detail, FIG. 2 shows first and second transponders as well as first and second antennas. In the example shown in FIG. 2, the aircraft includes a first civil transponder 100 and a second civil transponder 110. The aircraft also includes an upper antenna (e.g., first antenna) 101 and a lower antenna (e.g., second antenna) 102. The aircraft further includes a transponder control panel 130 used in association with first transponder 100 and/or second transponder 110. The examples shown in FIG. 2 are of course non-limiting and the technology described herein envisions any other variety of combination including, but not limited to, using one or more military transponders.

In a non-limiting example embodiment, the first civil transponder 100 may be operatively coupled to both upper antenna 101 and lower antenna 102. Although not shown in FIG. 2, the second civil transponder 110 may be operatively coupled to a separate upper antenna array and lower antenna array. In one example embodiment, the first civil transponder 100 and/or second civil transponder 110 may be directed coupled to respective antennas.

It should be appreciated that the first civil transponder 100 may use upper antenna 101 and lower antenna 102 in operation, while second civil transponder 110 may use separate antennas (e.g., should operation of first civil transponder 100 fail). This example is of course non-limiting and the technology described herein envisions and variety of operation between first civil transponder 100, second civil transponder 110, upper antenna 101, and/or lower antenna 102 (or any other associated antennas).

As discussed herein, a typical aircraft (e.g., commercial aircraft) may use two civil transponders (one for primary use and the other for secondary use). In some instances, it may be necessary to configure the aircraft for military deployment and as such, the aircraft will require a military transponder. The technology described herein allows for a reconfigurable transponder that can be used as a temporary replacement to one of the two civil transponders.

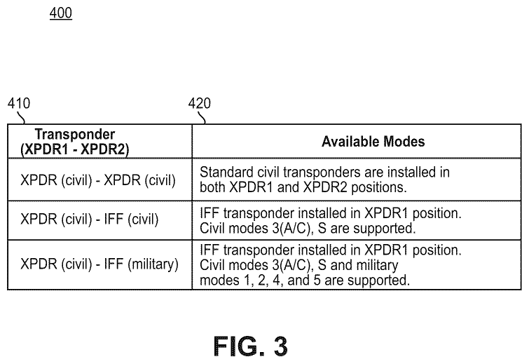

FIG. 3 shows a non-limiting example diagram showing different modes for a reconfigurable transponder arrangement. In the example shown in FIG. 3, table 400 includes a field for transponder selection 410 and transponder mode(s) 420. It should be appreciated that, as a non-limiting example, the various configurations described herein may include a dual civil transponder arrangement and/or a civil transponder and military transponder arrangement having a civil mode and/or a military mode.

In further detail, in a specific example embodiment, one IFF transponder may be installed in a mission equipment rack. When this transponder is not installed, XPDR1 and XPDR2 control panel settings correspond to two standard civil transponder units installed in the nose avionics compartment. When the IFF transponder is installed, the #1 standard civil circuit breaker is secured open and the IFF circuit breaker (CB) on the cockpit panel is engaged. This transponder is powered by the emergency bus through the IFF CB.

Position information to the transponder is provided by the flight management system when the IFF is in civil mode, and the military position data source in military modes. It should be appreciated that the configuration could require a change to the jumper harness assembly to the IFF unit (e.g., a physical wire changes where the signals originate). Antenna selection between #1 standard civil and IFF is provided by a switch in the forward equipment rack. Transponders can be set to at least one of three options for a particular configuration, as shown in the example of FIG. 3. It should be further appreciated that military position data may include, in a non-limiting example embodiment, embedded GPS/INS (EGI). These examples are of course non-limiting and the military position data source may include any variety of data sources.

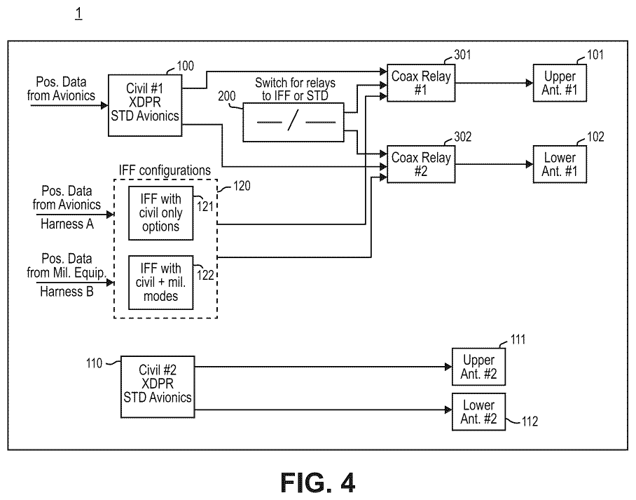

FIG. 4 shows a non-limiting example diagram of a system 1 (or configuration 1) for a reconfigurable transponder (e.g., in an aircraft). In an example embodiment, the system 1 can include at least the first civil transponder 100 and the second civil transponder 110, as well as a military transponder 120. The first civil transponder 100 is generally configured for use with the upper antenna 101 and the lower antenna 102, while the second civil transponder is generally configured for use with an upper antenna 111 and a lower antenna 112.

System 1 may also include a loader card to configure avionics of the aircraft. For example, loader card may include a software configuration loader card used to configure instruments used in the aircraft. In one example embodiment, system 1 may include software for operating in the different transponder configurations described herein. The software loader card may operate as a “key” to unlock (or enable) the aircraft to operate in one of the configurable modes. For example, the software loader card may enable system 1 to operate in the civil or military mode where the first civil transponder 100 and military transponder 120 are in operation.

The software loader card can be incorporated into any computer readable medium. In one example embodiment, the software loader card may be implemented via a flash memory (e.g., SD card, USB drive). But, this example is of course non-limiting and the technology described herein envisions any variety of media for implementing the software loader card.

It should be appreciated that military transponder 120 may operate in at least two configurations, as shown in the example table 400 of FIG. 3. In particular, military transponder can include a first configuration 121 which includes an IFF with a civil only option. The military transponder can also include a second configuration 122 which includes an IFF with civil and military modes.

It should be appreciated that to switch between civil only IFF modes and adding the Civil+Military modes of the IFF, besides having the loader card there may also be a physical jumper harness change needed to allow for the secure position data to come from the military equipment and GPS rather than from the standard avionics system. In one example embodiment, that can include a small jumper harness that is changed between the two IFF configurations. For example, position data from standard avionics may be used in a “harness A” configuration, while position data from military equipment may be used in a “harness B” configuration. That is, if IFF is installed with a “harness A,” loader card is configured for civil only (i.e., as first configuration 121). If IFF is installed with “harness B” loader card is configured to military mode (e.g., as second configuration 122).

System 1 may include a switch 200, first relay 301, and second relay 302. In one example embodiment, system 1 may be configured so that military transponder 120 is configured for use with upper antenna 101 and lower antenna 102. That is, first civil transponder 100 and military transponder 120 may “share” use of upper antenna 101 and lower antenna 102.

In one non-limiting example embodiment, first relay 301 (e.g., a first coax relay) and second relay 302 (e.g., a second coax relay) may be installed between first civil transponder 100, military transponder 120, upper antenna 101 and lower antenna 102. A switch 200 may also be installed to “drive” first relay 301 and second relay 302 to determine which of first civil transponder 100 or military transponder 120 is connected to upper antenna 101 and lower antenna 102. That is, the switch 200 is used to power the relays to switch the antennas between a military IFF transponder or the standard civil transponder (e.g., IFF or STD).

As shown in FIG. 4, output from first civil transponder 100 may be routed to first relay 301 and second relay 302. Likewise, output from military transponder 120 may be routed to first relay 301 and second relay 302. In one example embodiment, switch 200, first relay 301, and second relay 302 can allow system 1 to switch between one or more “civil” modes and one or more “military” modes as the configuration allows for system 1 to determine which transponder operates one of the antenna arrangements.

For example, in the “civil” mode, switch 200 can be operated to power relays 301/302 to allow antennas 101/102 to connect with the first civil transponder 100. Likewise, in the “military” mode, switch 200 can be operated to power relays 301/302 to allow antennas 101/102 to connect with the military transponder 120. In doing so, the civil transponder 100 or the military transponder 120 can be connected (e.g., using first relay 301 and second relay 302) to the upper antenna 101 and lower antenna 102. Under this approach, system 1 can advantageously allow for a commercial aircraft to be easily reconfigurable to operate in a military application. Moreover, the techniques described herein do not require any significant change to the aircraft configuration. For example, system 1 can operate using the different transponder configurations without requiring a further antenna relay (e.g., to accommodate a third transponder).

It should be appreciated that a military transponder 120 may be depicted as an IFF transponder with different mode configurations. Likewise, a first civil transponder 100 may be depicted as a standard civil transponder with standard transponder configurations (e.g., as used in commercial aircraft). As shown in FIG. 4, first civil transponder 100 and military transponder 120 have first relay 301 and second relay 302 installed therebetween. Switch 200 can be configured to operate first relay 301 and second relay 302 to determine which of first civil transponder 100 and/or military transponder 120 connect/communicate with first upper antenna 101 and first lower antenna 102.

As also discussed with respect to FIG. 4, output from first civil transponder 100 may be routed to upper antenna 101 via first relay 301 and lower antenna 102 via second relay 302. Likewise, output from military transponder 120 may be routed to upper antenna 101 via first relay 301 and lower antenna 102 via second relay 302. In one example embodiment, switch 200, first relay 301, and second relay 302 can allow system 1 to switch between one or more “civil” modes and one or more “military” modes as the configuration allows for system 1 to determine which transponder operates one of the antenna arrangements. In doing so, the upper antenna 101 and lower antenna 102 may be shared between the first civil transponder 100 and military transponder 120. Under this approach, and as one non-limiting example, system 1 can advantageously allow for a commercial aircraft to be easily reconfigurable to operate in a military application.

### Technical Advantages of Described Subject Matter

The technology described herein provides an improved configuration for a transponder arrangement. In particular, the technology described herein provides a reconfigurable transponder allowing for, among other aspects, a commercial aircraft to readily operate in a military application. As described herein, the installation of the military transponder is designed such that when installed it temporarily replaces one of the existing dual civil transponders, rather than permanently replacing one of them or being permanently installed.

The temporary, reconfigurable, aspect of this design is unique compared to traditional designs, and can be accomplished by coax relays tied to a switch, setting power by circuit breakers, and a loader card to configure the avionics. The design allows for temporary installing of a third transponder in an existing dual civil transponder architecture, without significant modification of the avionics to accommodate the three transponders.

### Further Applications of Described Subject Matter

As used in this document, the term “and/or” includes any and all combinations of one or more of the associated listed items.

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments.

Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

Although process steps, algorithms or the like, including without limitation with reference to any of the figures, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible.

Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed.

While the technology has been described in connection with what is presently considered to be an illustrative practical and preferred embodiment, it is to be understood that the technology is not to be limited to the disclosed embodiment, but on the contrary, is intended to cover various modifications and equivalent arrangements.

1. An aircraft, comprising:
avionics circuitry;
a first transponder;
a second transponder;
a third transponder;
a first relay;
a second relay;
a first antenna;
a second antenna; and
a switch, wherein
the first and second relay are configured for installation between the first transponder, the second transponder, and the third transponder, and the first and second antennas,
the switch is configured to enable the aircraft to operate in a first mode or a second mode,
in the first mode, the switch is configured to drive the first and second relays and connect the first and second transponders to the first and second antennas, and
in the second mode, the switch is configured to drive the first and second relays and connect the second and third transponders to the first and second antennas.

2. The aircraft of claim 1, wherein
the first transponder comprises a first civil transponder; and
the second transponder comprises a second civil transponder.

3. The aircraft of claim 2, wherein the third transponder comprises a military transponder.

4. The aircraft of claim 1, wherein the first relay and the second relay include coaxial relays.

5. The aircraft of claim 1, further comprising:
a first circuit breaker associated with the first transponder;
a second circuit breaker associated with the second transponder; and
a third circuit breaker associated with the third transponder, wherein
in the first mode, the third circuit breaker is set to disable power to the third transponder, and
in the second mode, the first circuit breaker or the second circuit breaker is set to disable power to the first transponder or the second transponder.

6. The aircraft of claim 1, wherein
a loader card enables flight software to operate in association with the first mode or the second mode, and
the loader card enables the flight software to operate in a civil mode, or operate in the civil mode and a military mode.

7. The aircraft of claim 1, further comprising a jumper harness enabling the aircraft to operate in a civil mode, or operate in the civil mode and a military mode.

8. A system, comprising:
a first transponder;
a second transponder;
a third transponder;
a first relay;
a second relay;
a first antenna;
a second antenna; and
a switch, wherein
the switch is configured to enable the system to operate in a first mode or a second mode,
in the first mode, the switch is configured to drive the first and second relays and connect the first and second transponders to the first and second antennas, and
in the second mode, the switch is configured to drive the first and second relays and connect the second and third transponders to the first and second antennas.

9. The system of claim 8, wherein the first and second relay are configured for installation between the first transponder, the second transponder, and the third transponder, and the first and second antennas.

10. The system of claim 8, wherein
the first transponder comprises a first civil transponder; and
the second transponder comprises a second civil transponder.

11. The system of claim 10, wherein the third transponder comprises a military transponder.

12. The system of claim 8, wherein the first relay and the second relay include coaxial relays.

13. The system of claim 8, further comprising:
a first circuit breaker associated with the first transponder;
a second circuit breaker associated with the second transponder; and
a third circuit breaker associated with the third transponder, wherein
in the first mode, the third circuit breaker is set to disable power to the third transponder, and
in the second mode, the first circuit breaker or the second circuit breaker is set to disable power to the first transponder or the second transponder.

14. The system of claim 8, wherein a loader card enables flight software to operate in association with the first mode or the second mode.

15. A transponder arrangement, comprising:
a first transponder;
a second transponder;
a third transponder;
a first relay;
a second relay; and
a switch, wherein
the switch is configured to enable an aircraft to operate in a first mode or a second mode,
in the first mode, the switch is configured to drive the first and second relays and connect the first and second transponders to first and second antennas, and
in the second mode, the switch is configured to drive the first and second relays and connect the second and third transponders to the first and second antennas.

16. The transponder arrangement of claim 15, wherein the first and second relay are configured for installation between the first transponder, the second transponder, and the third transponder, and the first and second antennas.

17. The transponder arrangement of claim 15, wherein
the first transponder comprises a first civil transponder;
the second transponder comprises a second civil transponder; and
the third transponder comprises a military transponder.

18. The transponder arrangement of claim 15, wherein the first relay and the second relay include coaxial relays.

19. The transponder arrangement of claim 15, wherein
the first transponder is associated with a first circuit breaker;
the second transponder is associated with a second circuit breaker; and
the third transponder is associated with a third circuit breaker, wherein
in the first mode, the third circuit breaker is set to disable power to the third transponder, and
in the second mode, the first circuit breaker or the second circuit breaker is set to disable power to the first transponder or the second transponder.

20. The transponder arrangement of claim 15, wherein a loader card enables flight software to operate in a civil mode, or operate in the civil mode and a military mode.
